(19) United States
(12) Patent Application Publication
(10) Pub. No.: US 2025/0056241 A1
(43) Pub. Date: Feb. 13, 2025

(54) METHODS FOR SUPPORTING COEXISTENCE IN THE PRESENCE OF NON-TERRESTRIAL NETWORKS

(71) Applicant: Telefonaktiebolaget LM Ericsson (publ), Stockholm (SE)

(72) Inventors: Olof LIBERG, Enskede (SE); Xingqin LIN, San Jose, CA (US); Jonas SEDIN, Brentford (GB); Emre YAVUZ, Stockholm (SE)

(21) Appl. No.: 18/719,410

(22) PCT Filed: Dec. 14, 2022
(86) PCT No.: PCT/SE2022/051178

§ 371 Date: Jun. 13, 2024

Related U.S. Application Data
(60) Provisional application No. 63/289,260, filed on Dec. 14, 2021.

(51) Int. Cl. H04W 16/14; H04W 24/08; H04W 84/04; H04W 84/06

(52) U.S. Cl. CPC H04W 16/14; H04W 24/08; H04W 84/042; H04W 84/06

(57) ABSTRACT

A method, system and apparatus for supporting coexistence in the presence of non-terrestrial networks are disclosed. According to one aspect, a method in a network node of a first radio network includes obtaining information of at least one measurement of a signal transmitted from a non-terrestrial network, NTN, node of a second radio network. The method also includes evaluating, based at least in part on the obtained information of the at least one measurement, whether criteria for coexistence of the first radio network with a second radio network are met.

### TECHNICAL FIELD

The present disclosure relates to wireless communications, and in particular, to supporting coexistence between wireless networks in presence of non-terrestrial networks.

### BACKGROUND

The Third Generation Partnership Project (3GPP) has developed and is developing standards for Fourth Generation (4G), also referred to as Long Term Evolution (LTE), and Fifth Generation (5G), also referred to as New Radio (NR), wireless communication systems. Such systems provide, among other features, broadband communication between network nodes, such as base stations, and mobile wireless devices (WD), as well as communication between network nodes and between WDs. Sixth Generation (6G) standards are under development.

In 3GPP Technical Release 8 (3GPP Rel-8), the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since 3GPP Rel-13, narrow band Internet of things (NB-IoT) and LTE machine (LTE-M) type communications are part of the LTE specifications and provide connectivity to massive machine type communications (mMTC) services.

In 3GPP Rel-15, the first release of the 5G system (5GS) was specified. This is a new generation's radio access technology intended to serve use cases such as enhanced mobile broadband (eMBB), ultra-reliable and low latency communication (URLLC), and mMTC. 5G includes the New Radio (NR) access stratum interface and the 5G Core Network (5GC). The NR physical and higher layers reuse parts of the LTE specification, and to that add needed components when motivated by new use cases. One such component is the introduction of a sophisticated framework for beam forming and beam management to extend the support of the 3GPP technologies to a frequency range going beyond 6 GHz.

In 3GPP Rel-15, 3GPP started the work to prepare NR for operation in a Non-Terrestrial Network (NTN). The work was performed within the study item “NR to support Non-Terrestrial Networks”. In 3GPP Rel 16, the work to prepare NR for operation in an NTN network continued with the study item “Solutions for NR to support Non-Terrestrial Network”. In parallel, the interest to adapt NB-IoT and LTE-M for operation in NTN is growing. As a consequence, 3GPP Rel-17 contains work items on NR, NB-IoT and LTE-M support for NTN. The work on 3GPP Rel-18 is starting in 2022. One likely objective for that work is to support terrestrial network (TN) to NTN service continuity, and measurements for facilitating this.

Besides the work done by the 3GPP, several initiatives are currently making preparations for launching large non-geosynchronous (NGSO) satellite constellations. Both Space X and OneWeb deploy constellations containing thousands of satellites.

### NTN

3GPP NTN includes both satellite communication and communications using high-altitude platforms (HAPS). Satellite communication is explained below, but the provided description could also be applied to a HAPS network. A satellite radio access network usually includes the following components:
A satellite that refers to a space-borne platform;
An earth-based gateway that connects the satellite to a base station or a core network, depending on the choice of architecture;
Feeder link that refers to the link between a gateway and a satellite;
An access link that refers to the link between a satellite and a WD. Depending on the orbit altitude, a satellite may be categorized as low earth orbit (LEO), medium earth orbit (MEO), or geostationary earth orbit (GEO) satellite:
   LEO: typical heights ranging from 250-1,500 km, with orbital periods ranging from 90-120 minutes;
   MEO: typical heights ranging from 5,000-25,000 km, with orbital periods ranging from 3-15 hours; and
   GEO: height at about 35,786 km, with an orbital period of 24 hours.

A communication satellite typically generates several beams over a given area. The footprint of a beam is usually in an elliptic shape, which has been traditionally considered as a cell. The footprint of a beam is also often referred to as a spotbeam. The footprint of a beam may move over the earth surface with the satellite movement or may be earth fixed with some beam pointing mechanism used by the satellite to compensate for its motion. The size of a spotbeam depends on the system design, which may range from tens of kilometers to a few thousands of kilometers.

FIG. 1 is an example architecture of a satellite network with bent pipe transponders. The depicted elevation angle of the service link impacts the distance between the satellite and the device, and the velocity of the satellite relative to the device. Also see the examples in FIGS. 2 and 3.

The satellite orbit is determined based on ephemeris data. 3GPP has agreed that ephemeris data of a serving satellite should be provided to the WD, for example to assist with pointing a directional antenna (or an antenna beam) towards the satellite. A WD knowing its own position, e.g., thanks to Global Navigation Satellite System (GNSS) support, may also use the ephemeris data to calculate correct Timing Advance (TA) and Doppler shift used when establishing a link to the satellite.

### Frequency Allocation and Coexistence Mechanisms

The International Telecommunications Union (ITU-R) radio regulations (RR) specify the assignment and use of frequencies agreed to by the members of the ITU. It also defines rules for efficient sharing of assigned frequency bands between different services including mobile services (MS) provided by mobile network operators and mobile and fixed satellite services (MSS and FSS) provided by satellite operators.

One relevant example is the S-band located at 2 GHz. For this band the RR support MSS in the range 1980-2010 MHz (for uplink (UL)) and 2170-2200 MHz (for downlink (DL)), and 5G NR MS in the overlapping NR band n65 covering 1920-2010 (UL) and 2110-2200 (DL). The MSS and MS are allocated in the S-band on equal terms, and ITU-R leaves it up to national regulators to determine if MS or MSS are deployed within its nation boarders.

To facilitate coexistence between MSS and MS, e.g., across country borders the World Radio Conference 19 (WRC-19) agreed upon Resolution 212 which provides guidance on facilitating the mentioned coexistence. As an example, the resolution suggests that a satellite system should not generate a higher power flux-density (PFD) than-108.8 dBW/m2/MHz in the MS DL band of 2110-2200 MHz at the earth's surface to protect MS devices.

Another relevant example is the Ka-band in which several NGSO operators are deploying or plan to deploy satellite constellations providing fixed satellite services (FSS). The basic functionality for facilitating coexistence among them is by means of coordination. According to ITU-R, in case coordination in a frequency band cannot be agreed upon between two NGSO operators, then the operator who first filed for the use of the frequency band should be granted prioritized use of the band. However, the FCC has adopted an alternative approach for NGSO operators. Public rounds were arranged during which NGSO operators can file for the right to use a fixed satellite service (FSS) frequency band. The two first processing rounds for the Ku-, Ka- and V-band licenses were initiated in 2016. During these rounds, the FCC granted licenses to 10 NGSO operators for launching NGSO constellations in the mentioned bands. These 10 operators are allowed to use the bands on an equal footing, and are expected to coordinate the use of the available frequency resources. In case coordination fails, the FCC mandates monitoring of the interference levels in the shared bands. The RR state that in case “the increase in system noise temperature of an earth station receiver, or a space station receiver for a satellite with onboard processing, of either system, ΔT/T, exceeds 6 percent due to interference from emissions originating in the other system in a commonly authorized frequency band, such frequency band will be divided among the affected satellite networks.”

To facilitate coexistence between NGSO and GSO systems FCC refers to Article 22 in the radio regulations (RR). It determines equivalent power flux densities (EPFD) that may not be exceeded for different percentages of time. For free space path loss conditions, EPFD is defined in the radio regulations as explained below. Compared to regular PFD the EPFD is scaled by the maximum receive antenna gain.

22.5C.1 The equivalent power flux-density is defined as the sum of the power flux-densities produced at a geostationary-satellite system receive station on the Earth's surface or in the geostationary orbit, as appropriate, by all the transmit stations within a non-geostationary-satellite system, taking into account the off-axis discrimination of a reference receiving antenna assumed to be pointing in its nominal direction. The equivalent power flux-density is calculated using the following formula:

$$epfd = 10 {log}_{10} ⌊ {\sum }_{i = 1}^{{N}_{a}} {10}^{\frac{{P}_{i}}{10}} \cdot \frac{{G}_{t} ( {θ}_{i} )}{4 π {d}_{i}^{2}} \cdot \frac{{G}_{r} ( {θ}_{i} )}{{G}_{r , max}} ⌋$$

where:
Nₐ: number of transmit stations in the non-geostationary-satellite system that are visible from the geostationary-satellite system receive station considered on the Earth's surface or in the geostationary orbit, as appropriate
i: index of the transmit station considered in the non-geostationary-satellite system
Pᵢ: RF power at the input of the antenna of the transmit station, considered in the non-geostationary-satellite system (dBW) in the reference bandwidth
θᵢ: off-axis angle between the boresight of the transmit station considered in the non-geostationary-satellite system and the direction of the geostationary-satellite system receive station
Gᵣ(θᵢ): transmit antenna gain (as a ratio) of the station considered in the non-geostationary-satellite system in the direction of the geostationary-satellite system receive station
dᵢ: distance (m) between the transmit station considered in the non-geostationary-satellite system and the geostationary-satellite system receive station
φᵢ: off-axis angle between the boresight of the antenna of the geostationary-satellite system receive station and the direction of the i-th transmit station considered in the non-geostationary-satellite system
Gᵣ(φᵢ): receive antenna gain (as a ratio) of the geostationary-satellite system receive station in the direction of the i-th transmit station considered in the non-geostationary-satellite system
G_{r,max}: maximum gain (as a ratio) of the antenna of the geostationary-satellite system receive station
epfd: computed equivalent power flux-density (dB(W/m²)) in the reference bandwidth. (WRC-2000)

Coordination can also be achieved by avoidance of inline interference events between competing operators. In practice this means that the beams from the competing satellite systems are spatially isolated. This is achieved by an angular separation of the main beams, and suppression of beam side-lobes. Different satellites may also use orthogonal polarizations, to allow a reuse of the same frequency band.

### Remote Interference Management in 5G NR Release 16

In 3GPP Rel-16, a work item called Remote Interference Management (RIM) was started whose purpose was to introduce methods for managing remote interference between base stations. Remote interference problems are observed in time division duplex (TDD) networks when interference is introduced at very large distances due to atmospheric conditions. The large distances introduce a mismatch in TDD patterns. Among the mechanisms introduced are the reference signals (RIM RS) that are designed so that a network node, e.g., gNB, can monitor the interference introduced by other gNBs that are far away. The RIM RS will indicate the network node, e.g., gNB, identifiers and the RIM RS transmission and reception can be configured by the operation, administration and management (OAM) functionality so that a network node, e.g., gNB, can monitor whether it is affected by remote interference.

The 3GPP has agreed to introduce support for 5G NR based MSS in the 1980-2010 MHz region of the wireless spectrum in UL and 2170-2200 MHz in DL, from 3GPP Rel-17. This band overlaps with band n65 covering 1920-2010 and 2110-2200 for NR based MS.

3GPP is expected to continue the evolution of NTN in 3GPP Rel-18. It is proposed to specify support for 5G NR satellite operation in the Ka-band covering the frequency range 17.7-20.2 (DL, i.e., satellite to WD) and 27.5-30.0 GHz (UL, i.e., WD to satellite). It is expected that these frequency ranges will be utilized by multiple NGSO and GSO operators. 3GPP Rel-18 is also likely to support terrestrial network (TN) to NTN service continuity, and measurements for facilitating this.

For these cases the earlier mentioned regulations for coexistence between TN and NTN operators making use of the same spectrum becomes relevant.

### SUMMARY

Some embodiments advantageously provide methods, systems, and apparatuses for supporting coexistence in the presence of non-terrestrial networks.

The 3GPP does not support the needed measurement definitions and measurement and reporting procedures for efficiently supporting the Resolution 212 and Article 22 coexistence measures.

Methods are presented to facilitate co-existence between different satellite constellations and terrestrial networks that share a spectrum.

Relevant measurement definitions and procedures are disclosed to support well established coexistence measures for 5G NR terrestrial and non-terrestrial network service providers making use of the same spectrum assets. Facilitating coexistence for terrestrial and non-terrestrial networks is a step on the way towards supporting terrestrial to non-terrestrial network service continuity. This is facilitated by providing support for measurement and reporting of PFD, EPFD, and polarization of a competing 3GPP network provider that exposes the measuring device or network node to co-channel interference. An advantage of some embodiments is allowance of a 3GPP network operator to monitor to ensure that a competing operators is honoring the national and international coexistence measurements agreed by the Federal Communication Commission (FCC) and the ITU-R.

According to one aspect, a first network node is configured to obtain, by including a radio interface configured to obtain, information of at least one measurement of a signal transmitted from a non-terrestrial network, NTN, node. The first network node also includes processing circuitry in communication with the radio interface and configured to evaluate, based at least in part on the obtained information of the at least one measurement, whether criteria for coexistence of the first radio network with a second radio network are met.

According to this aspect, in some embodiments, the NTN node is included in the second radio network and the first network node being configured to obtain the information of at least one measurement of a signal transmitted from the NTN node includes the first network node being configured to perform the at least one measurement of a signal transmitted from the NTN node. In some embodiments, the first network node is a terrestrial network node and the NTN node has a spotbeam that overlaps with a cell of the first network node. In some embodiments, the first network node is further configured to communicate with the second radio network when the criteria for coexistence of the first radio network with the second radio network are met. In some embodiments, the first network node is further configured to report to the second radio network, based at least in part on the evaluation, the information of the at least one measurement when the criteria for coexistence of the second radio network with the first radio network are not met. In some embodiments, the least one measurement includes measurement of at least one of power flux density, PFD, equivalent power flux density, EPFD, system noise temperature due to transmissions from the second radio network and polarization used for transmissions from the second radio network. In some embodiments, the at least one measurement is associated with at least a number of physical resource blocks associated with a sub band of frequencies of the second radio network. In some embodiments, the first network node is further configured to detect interference from the NTN node. The interference may be detected based at least in part on non-terrestrial network, NTN, specific reference signals.

According to this aspect, in other embodiments, the first network node is configured to communicate with a wireless device, WD, the WD being configured to perform measurements on transmissions from the first network node. In these embodiments, the first network node is the NTN node and the first network node, i.e. the NTN node, being configured to obtain the information of at least one measurement of a signal transmitted from the NTN node includes the NTN node being configured to receive the information of the at least one measurement from the WD.

According to this aspect, in further embodiments, the first network node is the NTN node and the first network node, i.e. the NTN node, being configured to obtain the information of at least one measurement of a signal transmitted from the NTN node includes the NTN node being configured to receive said information from the second radio network.

In some embodiments where the first network node is the NTN node, the NTN node has a spotbeam that overlaps with a cell of a network node in the second radio network. In some embodiments, the first network node, i.e. the NTN node, is further configured to communicate with the second radio network when the criteria for coexistence of the first radio network with the second radio network are met. In some embodiments, the NTN node is further configured to adapt transmissions to meet the criteria for coexistence of the first radio network with the second radio network, the adapting being based at least in part on the evaluation. In some embodiments, the at least one measurement includes measurement of at least one of power flux density, PFD, equivalent power flux density, EPFD, system noise temperature due to transmissions from the first radio network and polarization used for transmissions from the first radio network. In some embodiments, the at least one measurement is associated with at least a number of physical resource blocks associated with a sub band of frequencies of the first radio network.

In some embodiments, the criteria for coexistence of the first radio network with the second radio network are criteria in support of at least one of World Radio Conference 19, WRC-19, Resolution 212 and International Telecommunications Union (ITU-R) radio regulations (RR) Article 22.

According to another aspect, a method performed by a first network node of a first radio network includes: obtaining information of at least one measurement of a signal transmitted from a non-terrestrial network, NTN, node; and evaluating, based at least in part on the obtained information of the at least one measurement, whether criteria for coexistence of the first radio network with a second radio network are met.

According to this aspect, in some embodiments, the NTN node is included in the second radio network and obtaining the information of at least one measurement of a signal transmitted from the NTN node comprises performing, by the first network node, the at least one measurement of a signal from the NTN node. In some embodiments, the first network node is a terrestrial network node and the NTN node has a spotbeam that overlaps with a cell of the first network node. In some embodiments, the method further comprises communicating with the second radio network when the criteria for coexistence of the first radio network with the second radio network are met. In some embodiments, the method further comprises reporting to the second radio network, based at least in part on the evaluation, the information of the at least one measurement when the criteria for coexistence of the second radio network with the first radio network are not met. In some embodiments, the least one measurement includes measurement of at least one of power flux density, PFD, equivalent power flux density, EPFD, system noise temperature due to transmissions from the second radio network and polarization used for transmissions from the second radio network. In some embodiments, the at least one measurement is associated with at least a number of physical resource blocks associated with a sub band of frequencies of the second radio network. In some embodiments, the first network node is further configured to detect interference from the NTN node. The interference may be detected based at least in part on non-terrestrial network, NTN, specific reference signals.

According to this aspect, in other embodiments, the first network node is configured to communicate with a wireless device, WD, the WD being configured to perform measurements on transmissions from the first network node. In these embodiments, the first network node is the NTN node and obtaining the information of at least one measurement of a signal transmitted from the NTN node comprises receiving, by the first network node, i.e. the NTN node, the information of the at least one measurement from the WD.

According to this aspect, in further embodiments, the first network node is the NTN node and obtaining the information of at least one measurement of a signal transmitted from the NTN node comprises receiving, by the first network node, i.e. the NTN node, said information from the second radio network.

In some embodiments where the first network node is the NTN node, the NTN node has a spotbeam that overlaps with a cell of a network node in the second radio network. In some embodiments, the method further comprises communicating with the second radio network when the criteria for coexistence of the first radio network with the second radio network are met. In some embodiments, the method further comprises adapting transmissions to meet the criteria for coexistence of the first radio network with the second radio network, the adapting being based at least in part on the evaluation. In some embodiments, the at least one measurement includes measurement of at least one of power flux density, PFD, equivalent power flux density, EPFD, system noise temperature due to transmissions from the first radio network and polarization used for transmissions from the first radio network. In some embodiments, the at least one measurement is associated with at least a number of physical resource blocks associated with a sub band of frequencies of the first radio network.

In some embodiments, the criteria for coexistence of the first radio network with the second radio network are criteria in support of at least one of World Radio Conference 19, WRC-19, Resolution 212 and International Telecommunications Union (ITU-R) radio regulations (RR) Article 22.

According to yet another aspect, a first network node of a first radio network is provided, the first network node configured to communicate with a wireless device, WD, the WD being configured to perform measurements on transmissions from a second network node of a second radio network. The first network node includes a radio interface configured to receive from the WD information of at least one measurement of a signal from the second network node. The first network node also includes processing circuitry in communication with the radio interface and configured to evaluate, based at least in part on the received information of the at least one measurement, whether criteria for coexistence of the second radio network with the first radio network are met. The first network node also includes the radio interface being further configured to communicate with the second radio network when the criteria for coexistence of the second radio network with the first radio network are met.

According to this aspect, in some embodiments, the first network node is a non-terrestrial network, NTN, node. In some of these embodiments, the second network node is a terrestrial network node. In some other embodiments, the first network node is a terrestrial network node and the second network node is an NTN node. In some embodiments, the first network node is further configured to report to the second radio network, based at least in part on the evaluation, the information of the at least one measurement when the criteria for coexistence of the second radio network with the first radio network are not met. In some embodiments, the at least one measurement includes at least one of power flux density, PFD, equivalent power flux density, EPFD, system noise temperature due to transmissions from the second radio network and polarization used for transmissions from the second radio network. In some embodiments, the at least one measurement is associated with at least a number of physical resource blocks associated with a sub band of frequencies of the second radio network. In some embodiments, the first network node is further configured to detect interference from the second network node. In some embodiments, the interference is detected based at least in part on non-terrestrial network, NTN,-specific reference signals. In some embodiments, the criteria for coexistence of the second radio network with the first radio network are criteria in support of at least one of World Radio Conference 19, WRC-19, Resolution 212 and International Telecommunications Union (ITU-R) radio regulations (RR) Article 22.

According to yet another aspect, a method performed by a first network node of a first radio network is provided. The first network node is configured to communicate with a wireless device, WD, the WD being configured to perform measurements on transmissions from a second network node of a second radio network. The method includes receiving from the WD information of at least one measurement of a signal from the second network node, The method also includes evaluating, based at least in part on the received information of the at least one measurement, whether criteria for coexistence of the second radio network with the first radio network are met. The method further includes communicating with the second radio network when the criteria for coexistence of the second radio network with the first radio network are met. In some embodiments, the first network node is a non-terrestrial network, NTN, node. In some of these embodiments, the second network node is a terrestrial network node. In some other embodiments, the first network node is a terrestrial network node and the second network node is an NTN node. In some embodiments, the method further comprises reporting to the second radio network, based at least in part on the evaluation, the information of the at least one measurement when the criteria for coexistence of the second radio network with the first radio network are not met. In some embodiments, the at least one measurement includes at least one of power flux density, PFD, equivalent power flux density, EPFD, system noise temperature due to transmissions from the second radio network and polarization used for transmissions from the second radio network. In some embodiments, the at least one measurement is associated with at least a number of physical resource blocks associated with a sub band of frequencies of the second radio network. In some embodiments, the first network node is further configured to detect interference from the second network node. In some embodiments, the interference is detected based at least in part on non-terrestrial network, NTN,-specific reference signals. In some embodiments, the criteria for coexistence of the second radio network with the first radio network are criteria in support of at least one of World Radio Conference 19, WRC-19, Resolution 212 and International Telecommunications Union (ITU-R) radio regulations (RR) Article 22.

According to another aspect, a wireless device, WD, is configured to communicate with a first network node of a first radio network and to perform measurements on transmissions from a non-terrestrial network, NTN, node. The WD includes processing circuitry configured to perform at least one measurement of a signal from the NTN node, the at least one measurement being defined to support evaluation of criteria for coexistence of the first radio network with a second radio network. The WD also includes a radio interface in communication with the processing circuitry and configured to transmit information of the at least one measurement to the first network node.

According to this aspect, in some embodiments, the first network node is the NTN node. In some of these embodiments, the NTN node has a spotbeam that overlaps with a cell of a network node in the second radio network. In some embodiments, the at least one measurement includes measurement of at least one of power flux density, PFD, equivalent power flux density, EPFD, system noise temperature due to transmissions from the first radio network and polarization used for transmissions from the first radio network. In some embodiments, the at least one measurement is associated with at least a number of physical resource blocks associated with a sub band of frequencies of the first radio network.

According to this aspect, in other embodiments, the NTN node is comprised in the second radio network. In some of these embodiments, the NTN node has a spotbeam that overlaps with a cell of the first network node. In some embodiments, the at least one measurement includes measurement of at least one of power flux density, PFD, equivalent power flux density, EPFD, system noise temperature due to transmissions from the second radio network and polarization used for transmissions from the second radio network. In some embodiments, the at least one measurement is associated with at least a number of physical resource blocks associated with a sub band of frequencies of the second radio network.

In some embodiments, the criteria for coexistence of the first radio network with the second radio network are criteria in support of at least one of World Radio Conference 19, WRC-19, Resolution 212 and International Telecommunications Union (ITU-R) radio regulations (RR) Article 22.

According to yet another aspect, a method is performed by a wireless device, WD, configured to communicate with a first network node of a first radio network and to perform measurements on transmissions from a non-terrestrial network, NTN, node. The method includes performing at least one measurement of a signal from the NTN node, the at least one measurement being defined to support evaluation of criteria for coexistence of the first radio network with a second radio network. In some embodiments, the method includes transmitting information of the at least one measurement to the first network node.

According to this aspect, in some embodiments, the first network node is the NTN node. In some of these embodiments, the NTN node has a spotbeam that overlaps with a cell of a network node in the second radio network. In some embodiments, the at least one measurement includes measurement of at least one of power flux density, PFD, equivalent power flux density, EPFD, system noise temperature due to transmissions from the first radio network and polarization used for transmissions from the first radio network. In some embodiments, the at least one measurement is associated with at least a number of physical resource blocks associated with a sub band of frequencies of the first radio network.

According to this aspect, in other embodiments, the NTN node is comprised in the second radio network. In some of these embodiments, the NTN node has a spotbeam that overlaps with a cell of the first network node. In some embodiments, the at least one measurement includes measurement of at least one of power flux density, PFD, equivalent power flux density, EPFD, system noise temperature due to transmissions from the second radio network and polarization used for transmissions from the second radio network. In some embodiments, the at least one measurement is associated with at least a number of physical resource blocks associated with a sub band of frequencies of the second radio network.

In some embodiments, the criteria for coexistence of the first radio network with the second radio network are criteria in support of at least one of World Radio Conference 19, WRC-19, Resolution 212 and International Telecommunications Union (ITU-R) radio regulations (RR) Article 22.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of communication between a satellite and a wireless device (WD) and a network node;

FIG. 2 is a diagram of overlap between a satellite footprint and a network node footprint;

FIG. 3 is a diagram of overlap between a first satellite footprint and a second satellite footprint;

FIG. 4 is a schematic diagram of an example network architecture illustrating a communication system according to principles disclosed herein;

FIG. 5 is a block diagram of a network node in communication with a wireless device over a wireless connection according to some embodiments of the present disclosure;

FIG. 6 is a flowchart of an example process in a network node for supporting coexistence in the presence of non-terrestrial networks;

FIG. 7 is a flowchart of an example process in a wireless device for supporting coexistence in the presence of non-terrestrial networks; and

FIG. 8 is a flowchart of another example process in a network node for supporting coexistence in the presence of non-terrestrial networks;

FIG. 9 is a flowchart of another example process in a network node for supporting coexistence in the presence of non-terrestrial networks;

FIG. 10 is a flowchart of another example process in a wireless device for supporting coexistence in the presence of non-terrestrial networks; and

FIG. 11 is a diagram of overlapping coverage of a network node footprint and a satellite footprint and transmission of satellite data to the network node via the overlapping footprints.

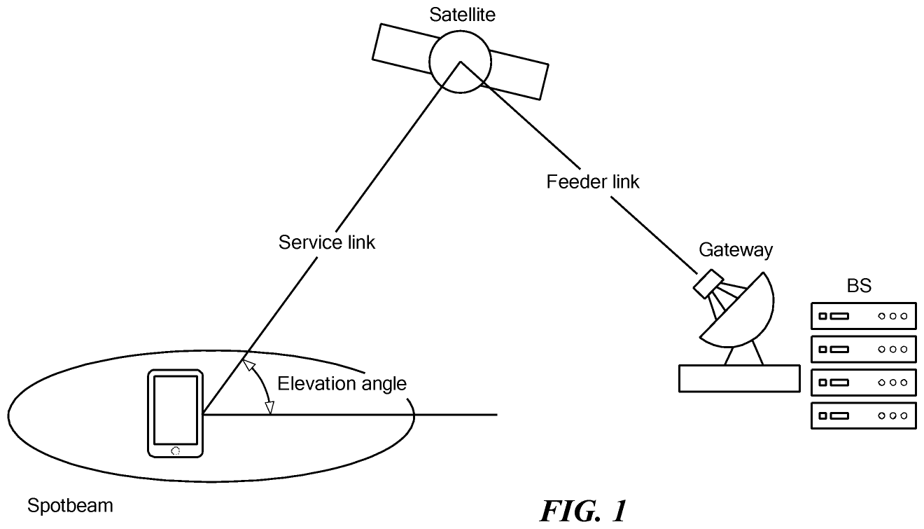

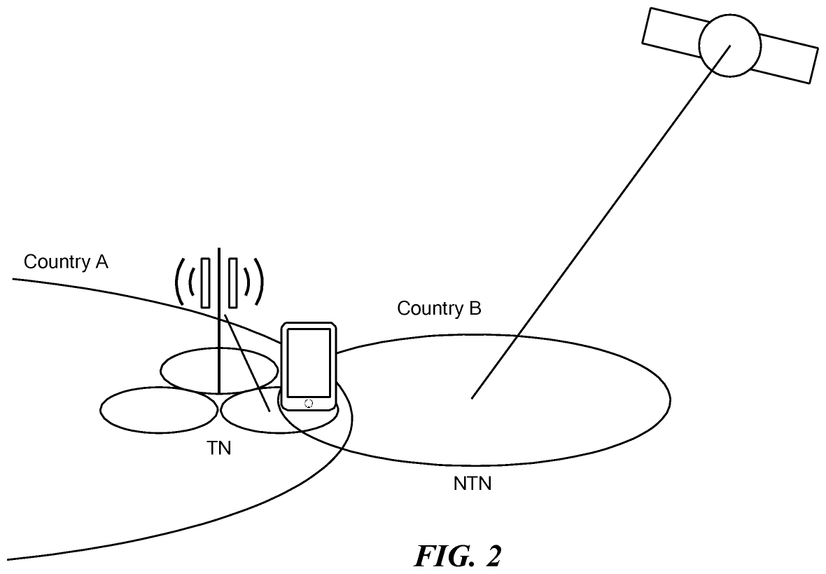

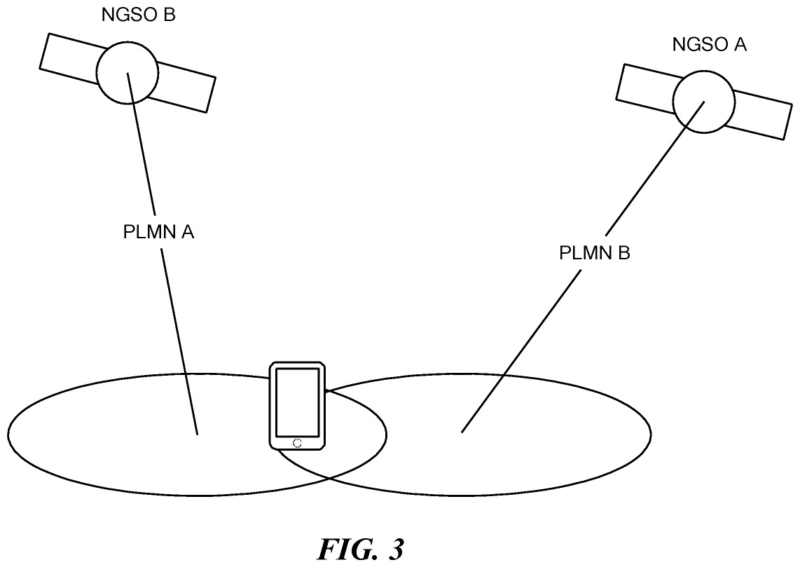

### DETAILED DESCRIPTION

Before describing in detail example embodiments, it is noted that the embodiments reside primarily in combinations of apparatus components and processing steps related to supporting coexistence in the presence of non-terrestrial networks. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipment (LEE), laptop mounted equipment (LME), USB dongles, Customer Premises Equipment (CPE), an Internet of Things (IoT) device, or a Narrowband IoT (NB-IoT) device etc. In some embodiments, the non-limiting term, WD, may also include a satellite radio, e.g., “satellite phone” configured for two way communication with an orbiting satellite.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

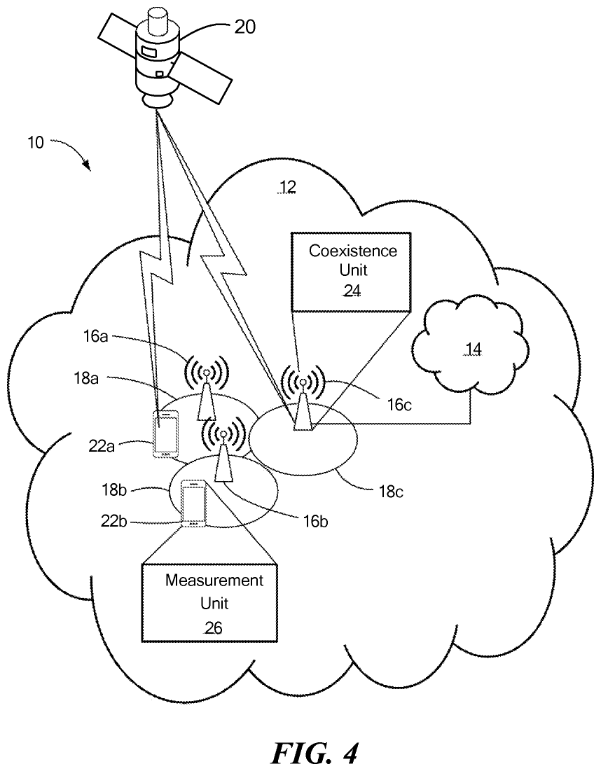

Some embodiments are directed to supporting coexistence in the presence of non-terrestrial networks. Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. FIG. 4 shows a scenario where the network node 16 is a TN node. In some embodiments, the network node 16 may be an NTN node and the WD 22 may be a satellite phone. The access network 12 comprises a plurality of terrestrial network nodes 16a, 16b, 16c (referred to collectively as terrestrial network (TN) network nodes 16), such as NBs, eNBs, gNBs or other types of wireless access points, each defining a corresponding coverage area 18a, 18b, 18c (referred to collectively as coverage areas 18). Each terrestrial network node 16a, 16b, 16c is connectable to the core network 14 over a wired or wireless connection. A first wireless device (WD) 22a located in coverage area 18a is configured to wirelessly connect to, or be paged by, the corresponding TN network node 16a. A second WD 22b in coverage area 18b is wirelessly connectable to the corresponding TN network node 16b. While a plurality of WDs 22a, 22b (collectively referred to as wireless devices 22) are illustrated in this example, the disclosed embodiments are equally applicable to a situation where a sole WD 22 is in the coverage area or where a sole WD 22 is connecting to the corresponding TN network node 16. Note that although only two WDs 22, three terrestrial network nodes 16 and one NTN network node 20 are shown for convenience, the communication system may include many more WDs 22, TN network nodes 16 and NTN network nodes 20.

Also, it is contemplated that a WD 22 can be in simultaneous communication and/or configured to separately communicate with more than one TN network node 16 and more than one type of TN network node 16. For example, a WD 22 can have dual connectivity with a TN network node 16 that supports LTE and the same or a different TN network node 16 that supports NR. As an example, WD 22 can be in communication with an eNB for LTE/E-UTRAN and a gNB for NR/NG-RAN.

A satellite, which may be referred to as non-terrestrial network (NTN) network node 20, may be configured with a radio interface 21 to engage in communication with earth-based and suborbital platforms such as a TN network node 16 and/or and one or more WDs 22. Thus, the NTN node 20 includes a radio interface 21 to communicate with WDs 22 and TN network nodes 16. For example, the TN network node 16 may be configured for two-way communication with the NTN network node 20 and a WD 22 may be configured to only receive signals from the NTN network node 20, while being configured for two-way communication with the TN network node 16. In some embodiments, a WD 22 may include a satellite phone to engage in two-way communications with the NTN network node 20.

A TN network node 16 (eNB or gNB) is configured to include a coexistence unit 24 which is configured to evaluate at least one measured parameter to determine whether the NTN meets criteria for coexistence with the TN. In some embodiments, the coexistence unit 24 is configured to evaluate, based at least in part on the received information of the at least one measurement, whether criteria for coexistence of one radio network with another radio network are met. A wireless device 22 is configured to include a measurement unit 26 which is configured to measure at least one parameter of a signal from the NTN network node 20. In some embodiments, the measurement unit 26 is configured to perform at least one measurement of a signal from the NTN node, the at least one measurement being defined to support evaluation of criteria for coexistence of one radio network with another radio network.

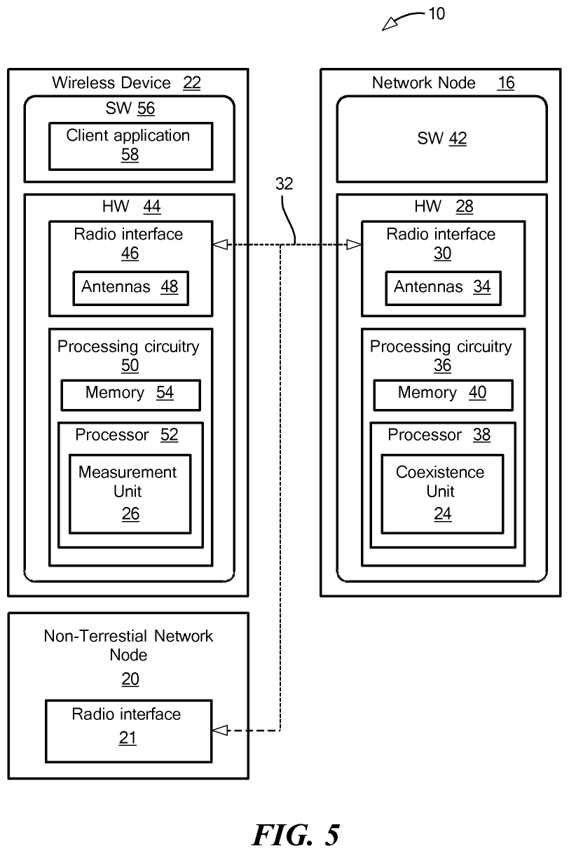

Example implementations, in accordance with an embodiment, of the WD 22 and TN network node 16 discussed in the preceding paragraphs will now be described with reference to FIG. 5. The network node 16, is in this example a TN node that is in communication with a WD 22 and an NTN 20.

The communication system 10 includes a TN network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the TN network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the TN network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the TN network node 16 further has software 42 stored internally in, for example, memory 40, or stored in external memory (e.g., database, storage array, network storage device, etc.) accessible by the TN network node 16 via an external connection. The software 42 may be executable by the processing circuitry 36. The processing circuitry 36 may be configured to control any of the methods and/or processes described herein and/or to cause such methods, and/or processes to be performed, e.g., by TN network node 16. Processor 38 corresponds to one or more processors 38 for performing TN network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to TN network node 16. For example, processing circuitry 36 of the TN network node 16 may include the coexistence unit 24 which is configured to evaluate at least one measured parameter to determine whether the NTN meets criteria for coexistence with the TN. In some embodiments, the coexistence unit 24 is configured to evaluate, based at least in part on the received information of the at least one measurement, whether criteria for coexistence of one radio network with another radio network are met.

The communication system 10 further includes the WD 22 already referred to. The WD 22 may have hardware 44 that may include a radio interface 46 configured to set up and maintain a wireless connection 32 with a TN network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include the measurement unit 26 which is configured to measure at least one parameter of a signal from the NTN network node. In some embodiments, the measurement unit 26 is configured to perform at least one measurement of a signal from the NTN node, the at least one measurement being defined to support evaluation of criteria for coexistence of one radio network with another radio network.

In some embodiments, the inner workings of the TN network node 16 and WD 22 may be as shown in FIG. 5 and independently, the surrounding network topology may be that of FIG. 4. While the network node 16 of FIG. 5 has in the above been referred to as a TN node, the network node 16 of FIG. 5 may in other examples be an NTN node in communication with a WD 22, e.g. a satellite phone.

The wireless connection 32 between the WD 22 and the TN network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 4 and 5 show various “units” such as coexistence unit 24 and measurement unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

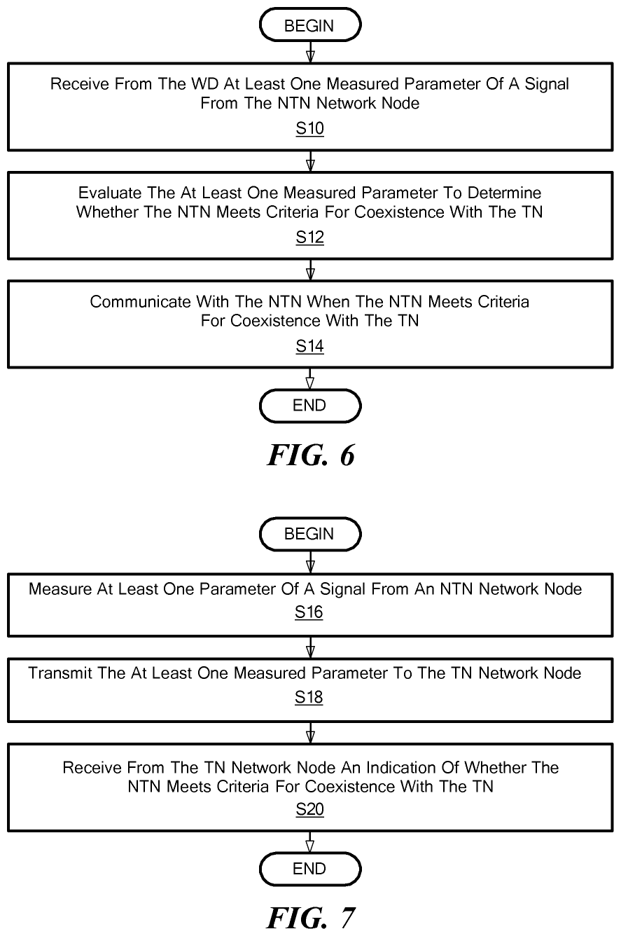

FIG. 6 is a flowchart of an example process in a TN network node 16 for supporting coexistence (with a NTN) in the presence of non-terrestrial networks. One or more blocks described herein may be performed by one or more elements of TN network node 16 such as by one or more of processing circuitry 36 (including the coexistence unit 24), processor 38, and/or radio interface 30. TN network node 16 such as via processing circuitry 36 and/or processor 38 and/or radio interface 30 is configured to receive from the WD 22 at least one measured parameter of a signal from the NTN network node 20 (Block S10). The process also includes evaluating the at least one measured parameter to determine whether the NTN meets criteria for coexistence with the TN (Block S12). The process also includes communicating with the NTN when the NTN meets criteria for coexistence with the TN (Block S14).

In some embodiments, the at least one measured parameter includes at least one of power flux density of a beam from the NTN network node 20, equivalent power flux density, system noise temperature and polarization. In some embodiments, the measured parameters are associated with at least a number of physical resource blocks associated with a sub band of frequencies of the NTN. In some embodiments, the method further includes detecting interference from the NTN network node 20. In some embodiments, the interference is detected based on NTN-specific reference signals.

FIG. 7 is a flowchart of an example process in a wireless device 22 according to some embodiments of the present disclosure. One or more blocks described herein may be performed by one or more elements of wireless device 22 such as by one or more of processing circuitry 50 (including the measurement unit 26), processor 52, and/or radio interface 46. Wireless device 22 such as via processing circuitry 50 and/or processor 52 and/or radio interface 46 is configured to measure at least one parameter of a signal from the NTN network node 20 (Block S16). The process also includes transmitting the at least one measured parameter to the TN network node 16 (Block S18). The process also includes receiving from the TN network node 16 an indication of whether the NTN meets criteria for coexistence with the TN (Block S20).

In some embodiments, the at least one measured parameter includes at least one of power flux density of a beam from the NTN network node 20, equivalent power flux density, system noise temperature and polarization. In some embodiments, the measured parameters are associated with at least a number of physical resource blocks associated with a sub band of frequencies of the NTN.

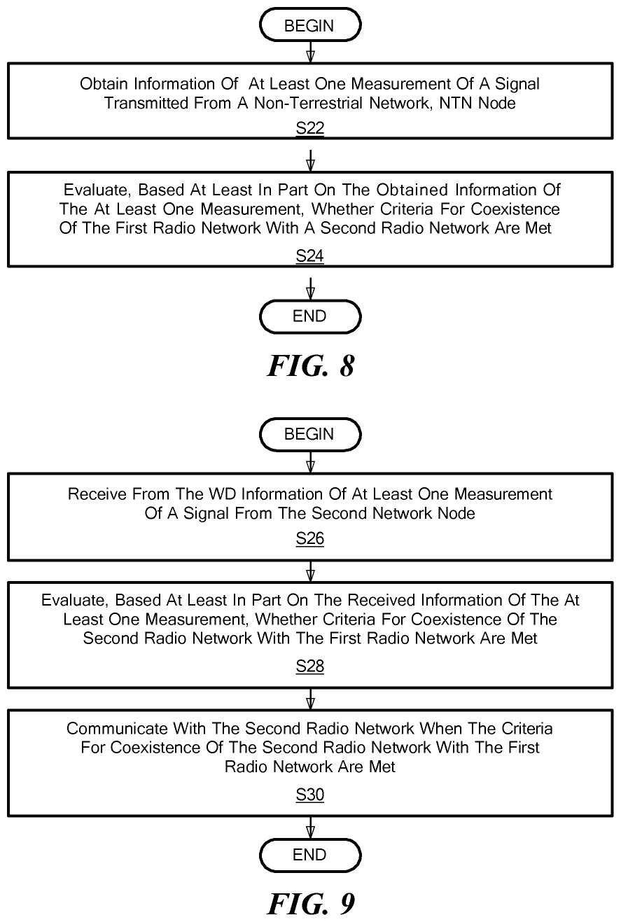

FIG. 8 is a flowchart of an example process in a first network node 16 of a first radio network for supporting coexistence (with a NTN) in the presence of non-terrestrial networks. The first network node 16 may be a terrestrial network node or a non-terrestrial network, NTN, node. One or more blocks described herein may be performed by one or more elements of network node 16 such as by one or more of processing circuitry 36 (including the coexistence unit 24), processor 38, and/or radio interface 30. Network node 16 such as via processing circuitry 36 and/or processor 38 and/or radio interface 30 is configured to obtain information of at least one measurement of a signal transmitted from a non-terrestrial network, NTN, node (Block S22). The process also includes evaluating, based at least in part on the received information of the at least one measurement, whether criteria for coexistence of the first radio network with a second radio network are met (Block S24).

In some embodiments, the NTN node is included in the second radio network and obtaining the information of at least one measurement of a signal transmitted from the NTN node comprises performing, by the first network node, the at least one measurement of a signal transmitted from the NTN node. In some embodiments, the first network node 16 is a terrestrial network node and the NTN node has a spotbeam that overlaps with a cell of the first network node 16. In some embodiments, the first network node 16 is further configured to communicate with the second radio network when the criteria for coexistence of the first radio network with the second radio network are met. In some embodiments, the method further comprises reporting to the second radio network, based at least in part on the evaluation, the information of the at least one measurement when the criteria for coexistence of the second radio network with the first radio network are not met. For example, the information of the at least one measurement may be reported to the NTN node of the second radio network. Furthermore, the information of the at least one measurement may for example be reported when the criteria for coexistence of the second radio network with the first radio network are not met by the NTN node. In some embodiments, the least one measurement includes measurement of at least one of power flux density, PFD, e.g. PFD of a beam from the NTN node, equivalent power flux density, EPFD, system noise temperature, or level of increase in system noise temperature, due to transmissions from the second radio network and polarization used for transmissions from the second radio network. In some embodiments, the at least one measurement is associated with at least a number of physical resource blocks associated with a sub band of frequencies of the second radio network. In some embodiments, the first network node 16 is further configured to detect interference from the NTN node. In some embodiments, the interference is detected based at least in part on non-terrestrial network, NTN, specific reference signals.

In some embodiments, the first network node 16 is configured to communicate with a wireless device, WD, the WD being configured to perform measurements on transmissions from the first network node 16, wherein the first network node 16 is the NTN node and wherein obtaining the information of at least one measurement of a signal transmitted from the first network node 16, i.e. from the NTN node, comprises receiving, by the NTN node, the information of the at least one measurement from the WD.

In some embodiments, the first network node 16 is the NTN node and obtaining the information of at least one measurement of a signal transmitted from the NTN node comprises receiving, by the NTN node, the information from the second radio network. The NTN node may in one example receive the information from a network node 16 in the second radio network. In some embodiments, the NTN node has a spotbeam that overlaps with a cell of the network node 16 in the second radio network. In some embodiments, the NTN node is further configured to communicate with the second radio network when the criteria for coexistence of the first radio network with the second radio network are met. In some embodiments, the NTN node is further configured to adapt transmissions to meet the criteria for coexistence of the first radio network with the second radio network, the adapting being based at least in part on the evaluation. For example, the NTN node may adapt its transmissions to meet the criteria for coexistence of the first radio network with the second radio network when the evaluation indicates that the criteria for coexistence of the first radio network with the second radio network are not met by the first radio network, and/or by the NTN node. In some embodiments, the at least one measurement includes measurement of at least one of power flux density, PFD, e.g. PFD of a beam from the NTN node, equivalent power flux density, EPFD, system noise temperature, or level of increase in system noise temperature, due to transmissions from the first radio network and polarization used for transmissions from the first radio network. In some embodiments, the at least one measurement is associated with at least a number of physical resource blocks associated with a sub band of frequencies of the first radio network. In some embodiments, the criteria for coexistence of the first radio network with the second radio network are criteria in support of at least one of World Radio Conference 19, WRC-19, Resolution 212 and International Telecommunications Union (ITU-R) radio regulations (RR) Article 22.

FIG. 9 is a flowchart of an example process in a first network node 16 of a first radio network for supporting coexistence with a second network node 16 of a second radio network in the presence of non-terrestrial networks. One or more blocks described herein may be performed by one or more elements of network node 16 such as by one or more of processing circuitry 36 (including the coexistence unit 24), processor 38, and/or radio interface 30. Network node 16 such as via processing circuitry 36 and/or processor 38 and/or radio interface 30 is configured to receive from the WD information of at least one measurement of a signal transmitted from the second network node 16 (Block S26). The process includes evaluating, based at least in part on the received information of the at least one measurement, whether criteria for coexistence of the second radio network with the first radio network are met (Block S28). The process includes communicating with the second radio network when the criteria for coexistence of the second radio network with the first radio network are met (Block S30).

In some embodiments, the first network node 16 is a non-terrestrial network, NTN, node. In some of these embodiments, the second network node 16 is a terrestrial network node. In some other embodiments, the first network node 16 is a terrestrial network node and the second network node 16 is an NTN node. In some embodiments, the method further comprises reporting to the second radio network, based at least in part on the evaluation, the information of the at least one measurement when the criteria for coexistence of the second radio network with the first radio network are not met. For example, the information of the at least one measurement may be reported to the second network node f the second radio network. Furthermore, the information of the at least one measurement may for example be reported when the criteria for coexistence of the second radio network with the first radio network are not met by the second network node. In some embodiments, the at least one measurement includes at least one of power flux density, PFD, e.g. PFD of a beam from the NTN node, equivalent power flux density, EPFD, system noise temperature, or level of increase in system noise temperature, due to transmissions from the second radio network and polarization used for transmissions from the second radio network. In some embodiments, the at least one measurement is associated with at least a number of physical resource blocks associated with a sub band of frequencies of the second radio network. In some embodiments, the first network node 16 is further configured to detect interference from the second network node 16. In some embodiments, the interference is detected based at least in part on non-terrestrial network, NTN,-specific reference signals. In some embodiments, the criteria for coexistence of the second radio network with the first radio network are criteria in support of at least one of World Radio Conference 19, WRC-19, Resolution 212 and International Telecommunications Union (ITU-R) radio regulations (RR) Article 22.

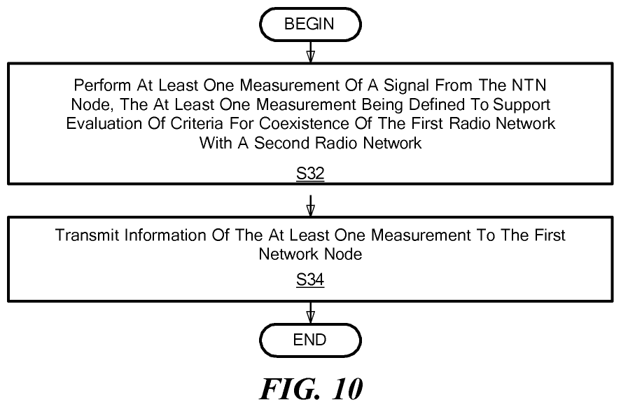

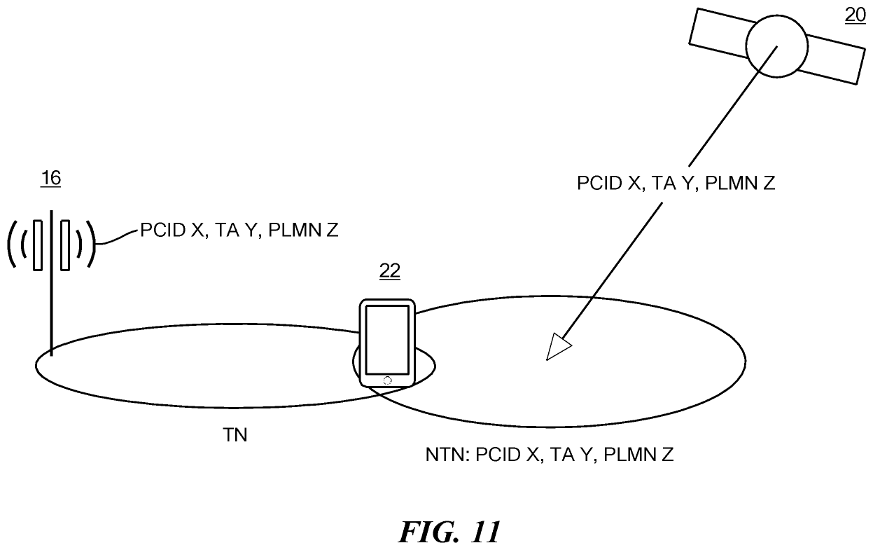

FIG. 10 is a flowchart of an example process in a wireless device 22 according to some embodiments of the present disclosure. The wireless device 22 is configured to communicate with the first network node 16 of the first radio network and to perform measurements on transmissions from a NTN node. One or more blocks described herein may be performed by one or more elements of wireless device 22 such as by one or more of processing circuitry 50 (including the measurement unit 26), processor 52, and/or radio interface 46. Wireless device 22 such as via processing circuitry 50 and/or processor 52 and/or radio interface 46 is configured to perform at least one measurement of a signal transmitted from the NTN node, the at least one measurement being defined to support evaluation of criteria for coexistence of the first radio network with a second radio network (Block S32). The process also includes transmitting information of the at least one measurement to the first network node 16 (Block S34).

In some embodiments, the first network node 16 is the NTN node. In some of these embodiments, the NTN node has a spotbeam that overlaps with a cell of a network node 16 in the second radio network. In some embodiments, the at least one measurement includes measurement of at least one of power flux density, PFD, e.g. PFD of a beam from the NTN node, equivalent power flux density, EPFD, system noise temperature, or level of increase in system noise temperature, due to transmissions from the first radio network and polarization used for transmissions from the first radio network. In some embodiments, the at least one measurement is associated with at least a number of physical resource blocks associated with a sub band of frequencies of the first radio network.

In other embodiments, the NTN node is comprised in the second radio network. In some of these embodiments, the NTN node has a spotbeam that overlaps with a cell of the first network node 16. In some embodiments, the at least one measurement includes measurement of at least one of power flux density, PFD, e.g. PFD of a beam from the NTN node, equivalent power flux density, EPFD, system noise temperature, or level of increase in system noise temperature, due to transmissions from the second radio network and polarization used for transmissions from the second radio network. In some embodiments, the at least one measurement is associated with at least a number of physical resource blocks associated with a sub band of frequencies of the second radio network.

In some embodiments, the criteria for coexistence of the first radio network with the second radio network are criteria in support of at least one of World Radio Conference 19, WRC-19, Resolution 212 and International Telecommunications Union (ITU-R) radio regulations (RR) Article 22.

Having described the general process flow of arrangements of the disclosure and having provided examples of hardware and software arrangements for implementing the processes and functions of the disclosure, the sections below provide details and examples of arrangements for supporting coexistence in the presence of non-terrestrial networks.

### Measurements

In some embodiments, a WD 22 in a first radio network is configured to perform one or more measurements on transmissions from a second radio network for the purpose of determining if the second radio network meets established criteria for coexistence with the first network.

Alternatively or in addition, the WD 22 may be configured to perform measurements on transmissions within its camped-on network for the purpose of determining if its own network meets established criteria for coexistence with a second network.

Examples of relevant measurement quantities are power flux density and equivalent power flux density (PFD). In some embodiments, the level of increase in system noise temperature due to the transmissions from the second network is measured. In some embodiments, the polarization (e.g., linear, right hand circular polarization (RHCP), left hand circular polarization (LHCP)) used by the transmitters in the second network is measured.

A WD 22 may be configured to measure the quantities (e.g., PFD, EPFD, and the level of increase in system noise temperature due to the transmissions from the second network) over an entire band and/or carrier and/or bandwidth part. In some embodiments, the band/carrier/bandwidth part may be divided into a set of subbands, where a subband may be defined as N contiguous physical resource blocks (PRBs). The subband size N may be configured and/or may depend on the total number of PRBs in the band/carrier/bandwidth part. For example, the subband size N may be higher in a band/carrier/bandwidth part with a large number of PRBs than in a band/carrier/bandwidth part with a smaller number of PRBs.

A WD 22 may be configured to scan the entire sky from horizon to horizon and perform, e.g., PFD measurements to produce a PFD map which represent the PFD experienced by the WD 22 in every possible direction. Alternatively, a WD 22 may be configured to scan in a certain direction or certain set of directions and perform, e.g., PFD measurements to produce a map per particular direction or a map per particular set of directions.

Network Node, e.g., gNB to Network Node, e.g., gNB, Measurements

In some embodiments, a first network node 16, 20 measures and detects interference from a second network node 20, 16, where the first network node is either a terrestrial or non-terrestrial network node and the second network is either a non-terrestrial network node or a terrestrial network node. This provides the benefit that the devices would not have to waste energy in making sure that co-existence works as intended.

The interference may for instance be measured through the use of NTN-specific reference signals that the terrestrial network node 16 or non-terrestrial network node 20 measures on, or it may be through RIM reference signals. The transmission and the reception of these reference signals may be coordinated in the terrestrial/non-terrestrial networks through the use of OAM. In case the terrestrial network (TN) 16 and NTN node 20 are in different core networks with different OAMs, the OAMs may coordinate with each other regarding which reference signals should be monitored.

Since satellite nodes, e.g., NTN network nodes 20, in non-terrestrial networks are moving and the nodes, e.g., TN network nodes 16, in terrestrial networks are not moving, the first network (if it is a non-terrestrial network) may be configured with the ephemeris, which gives information of the satellite trajectory and by extension the position of the satellite(s) and by further extension when the terrestrial network should monitor the specific satellites and its specific cells and/or reference signals.

As an example, the above could be implemented by extending the RIM RS OAM configurations by including the satellite ephemeris of each network node 16 in a set of network nodes 16.

### Device Reporting

In some embodiments, the WD 22 reports the measured quantities of the signal from the NTN network node 20, or the percentage of time a measured quantity exceeds a certain threshold, or if the measured quantities exceed a configured threshold, or if the percentage of time a measured quantity exceeds a first threshold exceeds a second threshold. Measurements exceeding certain thresholds are an indication of the camped on, or second external network, not meeting agreed coexistence criteria.

A reporting setting configuration may define a subset of subbands in the band/carrier/bandwidth part for the WD 22 to measure. The reporting setting configuration may configure the WD 22 with wideband or subband reporting. When wideband reporting is configured, the WD 22 may report the measured quantities, or the percentage of time a measured quantity exceeds a certain threshold, or if the measured quantities exceed a configured threshold, or if the percentage of time a measured quantity exceeds a first threshold exceeds a second threshold for the entire band/carrier/bandwidth part. When subband reporting is configured, the WD 22 reports the measured quantities, or the percentage of time a measured quantity exceeds a certain threshold, or if the measured quantities exceed a configured threshold, or if the percentage of time a measured quantity exceeds a first threshold exceeds a second threshold for each subband in the configured subset of subbands.

In some embodiments, the WD 22 is configured to measure on a second network or frequency, but also to record the identifiers of the network (physical cell (PCI) ID, timing advance (TA), public land mobile network (PLMN)) and report this to the TN network node 16. Additionally or alternatively, a cell identity (e.g., NCI in NR or E-EUTRAN cell identity (ECI) in evolved universal terrestrial radio access network (E-UTRAN)) may be used. Alternatively, a satellite-specific identifier may be introduced which is reported back by the WD 22. The satellite specific identifier may be global or only local for the operator. A benefit of this is that in some cases there may be multiple NTN network nodes 20, e.g., multiple satellites, covering the same area, and a simple indication of an issue may not be sufficient given that a single satellite network may cover the whole earth. Therefore, more information may be needed for the satellite network operator to take action. Similarly, a spotbeam identifier may be signaled for more granular information. This may be needed for LEO constellations where it is common that spotbeams are turned off to not interfere with certain regions.

In some embodiments, the WD 22 reports what the WD 22 is configured to measure on a second network per for example band/carrier/bandwidth part and reports such information with location and time stamp in addition to a network identifier, e.g., satellite specific identifier and/or beam identifier. See FIG. 11 which shows a WD 22 measuring parameters of an NTN signal and sending the measured parameters to a TN network node.

### Network Actions and Configurations

In some embodiments, the WD 22 is configured with the one or more identifiers (e.g., PLMN, cell IDs) of the second network to determine which transmissions to measure on.

If a network receives a report from WD 22s in its own network, or from another network, that contains measurement information indicating that it does not meet the agreed coexistence criteria, e.g., PFD limits at the earth surface, then it may use the reported information to adapt its transmissions to meet the coexistence limits.

PFD reports may, e.g., be used as input to a network power control algorithm determining the total power budget available to the nodes in the network. Also, the reports may be used as input to a network scheduling algorithm, which decides which part of band/carrier/bandwidth part to use to reduce interference so as to meet the coexistence criteria.

In some embodiments, a radio interface 21 of the NTN network node 20 in the first network measures the level of increase in system noise temperature due to the transmissions from earth stations in the second network. This is, for example, for the purpose of determining if the second network meets established criteria for coexistence with the first network in the uplink (earth to space).

Some embodiments may include one or more of the following.

Embodiment A1. A terrestrial network, TN, network node of a TN, the TN network node configured to communicate with a wireless device, WD, the WD being configured to receive signals from a non-terrestrial, network, NTN, network node of an NTN, the TN network node configured to, and/or comprising a radio interface and/or comprising processing circuitry configured to:
receive from the WD at least one measured parameter of a signal from the NTN network node;
evaluate the at least one measured parameter to determine whether the NTN meets criteria for coexistence with the TN; and
communicate with the NTN when the NTN meets criteria for coexistence with the TN.

Embodiment A2. The TN network node of Embodiment A1, wherein the at least one measured parameter includes at least one of power flux density of a beam from the NTN network node, equivalent power flux density, system noise temperature and polarization.

Embodiment A3. The TN network node of any of Embodiments A1 and A2, wherein the measured parameters are associated with at least a number of physical resource blocks associated with a sub band of frequencies of the NTN.

Embodiment A4. The TN network node of any of Embodiments A1-A3, wherein the TN network node, processing circuitry and/or radio interface are further configured to detect interference from the NTN network node.

Embodiment A5. The TN network node of Embodiment A4, wherein the interference is detected based on NTN-specific reference signals.

Embodiment B1. A method implemented in a terrestrial network, TN, network node of a TN, the TN network node configured to communicate with a wireless device, WD, the WD being configured to receive signals from a non-terrestrial, network, NTN, network node of an NTN, the method comprising:
receiving from the WD at least one measured parameter of a signal from the NTN network node;
evaluating the at least one measured parameter to determine whether the NTN meets criteria for coexistence with the TN; and
communicating with the NTN when the NTN meets criteria for coexistence with the TN.

Embodiment B2. The method of Embodiment B1, wherein the at least one measured parameter includes at least one of power flux density of a beam from the NTN network node, equivalent power flux density, system noise temperature and polarization.

Embodiment B3. The method of any of Embodiments B1 and B2, wherein the measured parameters are associated with at least a number of physical resource blocks associated with a sub band of frequencies of the NTN.

Embodiment B4. The method of any of Embodiments B1-B3, further comprising detecting interference from the NTN network node.

Embodiment B5. The method of Embodiment B4, wherein the interference is detected based on NTN-specific reference signals.

Embodiment C1. A wireless device, WD, configured to communicate with a terrestrial network, TN, network node of a TN and to receive signals from a non-terrestrial network NTN node of an NTN, the WD configured to, and/or comprising a radio interface and/or processing circuitry configured to:
measure at least one parameter of a signal from the NTN network node;
transmit the at least one measured parameter to the TN network node; and
receive from the TN network node an indication of whether the NTN meets criteria for coexistence with the TN.

Embodiment C2. The WD of Embodiment C1, wherein the at least one measured parameter includes at least one of power flux density of a beam from the NTN network node, equivalent power flux density, system noise temperature and polarization.

Embodiment C3. The WD of any of Embodiments C1 and C2, wherein the measured parameters are associated with at least a number of physical resource blocks associated with a sub band of frequencies of the NTN.

Embodiment D1. A method implemented in a wireless device (WD) configured to communicate with a terrestrial network, TN, network node of a TN and to receive signals from a non-terrestrial network NTN node of an NTN, the method comprising:
measuring at least one parameter of a signal from the NTN network node;
transmitting the at least one measured parameter to the TN network node; and
receiving from the TN network node an indication of whether the NTN meets criteria for coexistence with the TN.

Embodiment D2. The method of Embodiment D1, wherein the at least one measured parameter includes at least one of power flux density of a beam from the NTN network node, equivalent power flux density, system noise temperature and polarization.

Embodiment D3. The method of any of Embodiments D1 and D2, wherein the measured parameters are associated with at least a number of physical resource blocks associated with a sub band of frequencies of the NTN.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-17. (canceled)

18. A method performed by a first network node of a first radio network, the method comprising:
obtaining information of at least one measurement of a signal transmitted from a non-terrestrial network, NTN, node; and
evaluating, based at least in part on the obtained information of the at least one measurement, whether criteria for coexistence of the first radio network with a second radio network are met.

19. The method of claim 18, wherein the NTN node is included in the second radio network and wherein obtaining the information of at least one measurement of a signal transmitted from the NTN node comprises performing, by the first network node, the at least one measurement of a signal from the NTN node.

20.-44. (canceled)

45. A method performed by a first network node of a first radio network, the first network node configured to communicate with a wireless device, WD, the WD being configured to perform measurements on transmissions from a second network node of a second radio network, the method comprising:
receiving from the WD information of at least one measurement of a signal from the second network node;
evaluating, based at least in part on the received information of the at least one measurement, whether criteria for coexistence of the second radio network with the first radio network are met; and
communicating with the second radio network when the criteria for coexistence of the second radio network with the first radio network are met.

46.-48. (canceled)

49. The method of claim 45, wherein the method further comprises:
reporting to the second radio network, based at least in part on the evaluation, the information of the at least one measurement when the criteria for coexistence of the second radio network with the first radio network are not met.

50. The method of claim 45, wherein the at least one measurement includes at least one of power flux density, PFD, and equivalent power flux density, EPFD, system noise temperature due to transmissions from the second radio network and polarization used for transmissions from the second radio network.

51.-64. (canceled)

65. A method performed by a wireless device, WD, the WD configured to communicate with a first network node of a first radio network and to perform measurements on transmissions from a non-terrestrial network, NTN, node, the method comprising:
performing at least one measurement of a signal from the NTN node, the at least one measurement being defined to support evaluation of criteria for coexistence of the first radio network with a second radio network; and
transmitting information of the at least one measurement to the first network node.

66. The method of claim 65, wherein the first network node is the NTN node.

67. The method of claim 66, wherein the NTN node has a spotbeam that overlaps with a cell of a network node in the second radio network.

68. The method of claim 66, wherein the at least one measurement includes measurement of at least one of power flux density, PFD, equivalent power flux density, EPFD, system noise temperature due to transmissions from the first radio network and polarization used for transmissions from the first radio network.

69. The method of claim 66, wherein the at least one measurement is associated with at least a number of physical resource blocks associated with a sub band of frequencies of the first radio network.

70. The method of claim 65, wherein the NTN node is comprised in the second radio network.

71. The method of claim 70, wherein the NTN node has a spotbeam that overlaps with a cell of the first network node.

72. The method of claim 70, wherein the at least one measurement includes measurement of at least one of power flux density, PFD, and equivalent power flux density, EPFD, system noise temperature due to transmissions from the second radio network and polarization used for transmissions from the second radio network.

73. The method of claim 70, wherein the at least one measurement is associated with at least a number of physical resource blocks associated with a sub band of frequencies of the second radio network.

74. The method of claim 65, wherein the criteria for coexistence of the first radio network with the second radio network are criteria in support of at least one of World Radio Conference 19, WRC-19, Resolution 212 and International Telecommunications Union, ITU-R, radio regulations, RR, Article 22.

75. A first network node of a first radio network, the first network node comprising:
a radio interface; and
processing circuitry connectable to the radio interface, whereby the processing circuitry and the radio interface are configured to:
obtain information of at least one measurement of a signal transmitted from a non-terrestrial network, NTN, node; and
evaluate, based at least in part on the obtained information of the at least one measurement, whether criteria for coexistence of the first radio network with a second radio network are met.

76. The first network node of claim 75, wherein the NTN node is included in the second radio network and wherein the processing circuitry and the radio interface being configured to obtain the information of at least one measurement of a signal transmitted from the NTN node comprises the processing circuitry and the radio interface being configured to perform the at least one measurement of a signal from the NTN node.

77. A first network node of a first radio network, the first network node configured to communicate with a wireless device, WD, the WD being configured to perform measurements on transmissions from a second network node of a second radio network, the first network node comprising:
a radio interface; and
processing circuitry connectable to the radio interface, whereby the processing circuitry and the radio interface are configured to:
receive from the WD information of at least one measurement of a signal from the second network node;
evaluate, based at least in part on the received information of the at least one measurement, whether criteria for coexistence of the second radio network with the first radio network are met; and
communicate with the second radio network when the criteria for coexistence of the second radio network with the first radio network are met.

78. The first network node of claim 77, wherein the radio interface and the processing circuitry are further configured to report to the second radio network, based at least in part on the evaluation, the information of the at least one measurement when the criteria for coexistence of the second radio network with the first radio network are not met.

79. A wireless device, WD, configured to communicate with a first network node of a first radio network and to perform measurements on transmissions from a non-terrestrial network, NTN, node, the WD comprising:
processing circuitry; and
a radio interface connectable to the processing circuitry, whereby the processing circuitry and the radio interface are configured to:
perform at least one measurement of a signal from the NTN node, the at least one measurement being defined to support evaluation of criteria for coexistence of the first radio network with a second radio network; and
transmit information of the at least one measurement to the first network node.

80. The WD of claim 79, wherein the first network node is the NTN node.
